(19) United States
(12) Patent Application Publication
(10) Pub. No.: US 2010/0217812 A1
(43) Pub. Date: Aug. 26, 2010

(54) INTERCONNECTION OF VIRTUAL WORLDS BY MEANS OF MOBILE MESSAGE SERVICES

(75) Inventor: Matthias Roebke, Koeln (DE)

Correspondence Address: KF ROSS PC, 5683 RIVERDALE AVENUE, SUITE 203 BOX 900, BRONX, NY, 10471-0900, US

(73) Assignee: DEUTSCHE TELEKOM AG, Bonn (DE)

(21) Appl. No.: 12/673,802

(22) PCT Filed: Feb. 21, 2008
(86) PCT No.: PCT/EP2008/001379

§ 371 Date: Mar. 3, 2010

(30) Foreign Application Priority Data
Oct. 4, 2007 (DE) 10 2007 047 632.0

(51) Int. Cl. G06F 15/16

(52) U.S. Cl. 709/206

(57) ABSTRACT

The invention relates to a method for connecting data processing systems and/or computer networks that simulate virtual environments (1) by means of communication services (3), in particular mobile communication networks, especially mobile message services, in particular SMS, MMS, IM, e-mail or similar, to permit communication between users and/or services of virtual environments (1) and users and/or services of real, conventional communications services (3). According to said method, a connection and assignment between the source and/or target address of the virtual environment (1) and the source and/or target address of the communication services takes place by means of an interface (2) between the virtual environment (1) of the data processing system and/or the computer network and the communications service (3) and information is forwarded to a communications service (3) and vice versa.

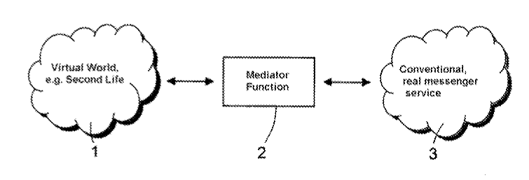

### CROSS REFERENCE TO RELATED APPLICATIONS

This application is the U.S. national phase of PCT application PCT/EP2008/001379, filed 21 Feb. 2008, published 16 Apr. 2009 as WO2009/046772, and claiming the priority of German patent application 102007047632.0 itself filed 4 Oct. 2007, whose entire disclosures are herewith incorporated by reference.

### FIELD OF THE INVENTION

The invention relates to a method of connecting data-processing systems and/or computer networks that simulate virtual environments by using messaging services, in particular, mobile radio networks, in particular, mobile messaging services, in particular, SMS, MMS, IM, email, and the like, to enable communication between users and/or services of virtual environments, and users and/or services of real conventional communications services.

### BACKGROUND OF THE INVENTION

The prior art shows that it is possible today to exchange data between users by conventional mobile communications services or messaging services (SMS, MMS, IM, email, etc.). In addition, it is also possible in “virtual environments” (such as, for example Second Life, Cyworld, Habbo, etc.) to exchange messages between identities of the virtual environment.

These types of virtual worlds or environments are simulated on data-processing systems, such as, for example, on a web server and/or in a computer network such as, for example the Internet. The term data-processing systems and/or computer networks should also be understood to include parts of a computer network.

According to the prior art, the exchange of messages in the “real” world is separate from the exchange of messages in “virtual” environments, i.e. users who are currently in a “virtual environment” cannot exchange messages with users of real mobile messaging services, such as, for example MMS, SMS, etc., and vice versa.

### OBJECT OF THE INVENTION

The object of the invention is to provide a method that enables both environments (the virtual and the real) to be interconnected so as to allow for an exchange of messages.

### SUMMARY OF THE INVENTION

This problem is solved according to the invention by a method wherein a connection and an assignment are done between source or target addresses of the virtual environment, and source and target addresses of the communications service by an interface between the virtual environment of the data-processing system, or of the computer network and the communications service, and that a transfer of information to a communications service is done, and vice versa.

What is especially advantageous about the method of connecting data-processing systems and/or computer networks that simulate virtual environments, comprising communications services, in particular, mobile radio networks, in particular, mobile messaging services, in particular, SMS, MMS, IM, email, and the like, to enable communication between users, and/or services of virtual environments, and users and/or services of real conventional communications services, is the fact that a connection and an assignment are done between source and/or target address of the virtual environment, and source and/or target address of the communications service by an interface between the virtual environment of the data-processing system, and/or of the computer network, and the communications service, and that a transfer of information to a communications service is done, and vice versa.

The fundamental idea of the invention is based on providing an interface and associated methods, that allow an exchange of information to be realized between virtual individuals and real users of a messaging service (MMS, IM, SMS, CPM).

The core element to achieve this is a mediator function that interconnects both worlds, i.e. constitutes the above-referenced interface.

The interface advantageously adapts the address, in particular between an alias in a virtual environment and an MSISDN that uniquely identifies a user of a communications service.

The interface also advantageously performs a protocol adaptation, in particular, an adaptation between proprietary protocols of the virtual environment and the standard protocols that are used in messaging services.

In addition, the interface can adapt the existing information with respect to the presence of users of a virtual and/or a real environment. The interface also can adapt existing information with respect to the location of users of a virtual and/or a real environment.

In a preferred embodiment of the method according to the invention, the interface bills for using services in a virtual environment, and/or for using communications services, and/or for using the interface function between the virtual environment and communications services.

In terms of its logical arrangement, the interface can be provided both in the virtual environment and also in the domain of a communications service.

### BRIEF DESCRIPTION OF THE DRAWING

The sole FIGURE of the drawing schematically illustrates one embodiment of the invention that is described below.

### SPECIFIC DESCRIPTION

The fundamental idea of the invention is based on providing an interface 2 and associated methods that allow an exchange of messages to be done between virtual individuals, i.e. users of a virtual world or virtual environment 1, and real users of a messaging service 3, i.e. of a communications service such as, for example, MMS, IM, SMS, CPM, or the like.

A key element to achieve this is a mediator function 2 that interconnects both worlds 1 and 3, i.e. a virtual environment 1 and (real) communications services 3.

This mediator function 2 enables an individual who is moving in a virtual environment 1 to use the entire spectrum of real messaging services 3 (for example to send SMS to real users, participate in real chats, use CPM conversations, etc.). In addition, it is possible for a virtual individual 1 to receive messages, etc. from real users of conventional messaging services 3.

The purpose of the mediator function, i.e. of interface 2, is to implement any adaptations that are necessary to interconnect both worlds or environments 1, 3.

Included here in particular are:
Adaptation of the address: for example MSISDN→alias in the virtual environment 1
Adaptation of the protocol: proprietary protocols of the virtual environment 1→standard protocols that are used in the messaging services 3.
Adaptation of presence information, i.e. an adaptation and/or evaluation of existing information about the presence of users of the virtual environment 1 and/or of the real environment 3.
   Adaptation of location information, i.e. an adaptation and/or evaluation of existing information about the location of users of virtual environment 1 and/or of real environment 3.

In addition, this interface item is responsible for possible charge billing for messages/services that are exchanged and/or utilized.

Logically, the mediator function 2 can be resident either in the environment of the “virtual world” 1 or in the domain of the the message services 3 to be utilized. In addition, the mediator function 2 can be structured as an independent entity.

1. A method of connecting data-processing systems or computer networks that simulate virtual environments, comprising communications services, in particular mobile radio networks, in particular mobile messaging services, in particular SMS, MMS, IM, email, and the like, to enable communication between users or services of virtual environments and users or services of real conventional communications services, wherein a connection and an assignment are done between source or target addresses of the virtual environment, and source or target addresses of the communications service by an interface between the virtual environment of the data-processing system, or of the computer network and the communications service, and that a transfer of information to a communications service is done, and vice versa.

2. The method according to claim 1, wherein an address adaptation is done by the interface, in particular, an adaptation between an alias in a virtual environment and an MSISDN in a mobile radio network.

3. The method according to claim 1 wherein a protocol adaptation is done by the interface, in particular, an adaptation between proprietary protocols of the virtual environment and the standard protocols that are used in messaging services.

4. The method according to claim 1 wherein an adaptation or evaluation of existing information about the presence of users of a virtual environment or of a real environment is done by the interface.

5. The method according to claim 1 wherein an adaptation or evaluation of existing information about the location of users of a virtual environment or of a real environment is done by the interface.

6. The method according to claim 1 wherein charge billing is done by the interface for using services in a virtual environment or for using communications services or for using the interface function between the virtual environment and communications services.

7. The method according to claim 1 wherein in terms of its logical arrangement the interface is either in the virtual environment or in the domain of a communications service.
